(19) United States
(12) Patent Application Publication
(10) Pub. No.: US 2009/0038306 A1
(43) Pub. Date: Feb. 12, 2009

(54) COOLING APPARATUS FOR CONTINUOUSLY VARIABLE TRANSMISSION

(76) Inventors: Byung Dae Choi, Seoul (KR); Hyunsuk Kim, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/951,044

(22) Filed: Dec. 5, 2007

(30) Foreign Application Priority Data
Aug. 7, 2007 (KR) 10-2007-0079203

(51) Int. Cl. B60K 11/02

(52) U.S. Cl. 60/456

(57) ABSTRACT

Light weight and a reduction of production cost can be achieved for a cooling apparatus of a CVT that uses a forward clutch and a reverse brake as launching clutches, when the cooling apparatus includes: a manual valve that receives and outputs a first hydraulic pressure for operating the launching clutches and that receives and outputs a second hydraulic pressure for cooling the launching clutches; a first hydraulic line for supplying the first hydraulic pressure to the manual valve; a second hydraulic line for supplying the first hydraulic pressure from the manual valve to the forward clutch; a third hydraulic line for supplying the second hydraulic pressure to the manual valve; and a fourth hydraulic line for supplying the second hydraulic pressure from the manual valve to the forward clutch.

### CROSS-REFERENCE TO RELATED APPLICATION

This application claims priority to and the benefit of Korean Patent Application No. 10-007-0079203, filed in the Korean Intellectual Property Office on Aug. 7, 2007, the entire contents of which are incorporated herein by reference.

### BACKGROUND OF THE INVENTION

(a) Field of the Invention

The present invention relates to a cooling apparatus of a continuously variable transmission. More particularly, the present invention relates to a cooling apparatus of a continuously variable transmission that enables light weight and a reduction of production cost of the transmission.

(b) Description of the Related Art

Typically, a continuously variable transmission uses a torque converter as a launching member, which is a member used for launching a vehicle, or it uses a frictional element of a forward clutch and a reverse brake as the launching member. In this case, the forward clutch is operated at a forward speed, and a reverse brake is operated at a reverse speed.

In the case of a continuously variable transmission (CVT) that uses the frictional element of the forward clutch and the reverse brake as the launching member, a substantial amount of slip occurs during its control, and therefore, a cooling apparatus is usually equipped for the frictional element.

That is, in order to cool the launching; member of the CVT, a hydraulic pressure for cooling the launching member is separately required, additionally to the hydraulic pressure for operating the launching member.

FIG. 3 is a schematic diagram that shows a conventional cooling apparatus of a CVT.

Referring to FIG. 3, a hydraulic pressure for operating launching members (i.e., a forward clutch 13 and a reverse brake 11) is inputted to a manual valve 23 through a first hydraulic line 19, and is selectively outputted through a second hydraulic line 27 to be supplied to a forward clutch 13 and through a third hydraulic line 29 to be supplied to a reverse brake 11.

By a movement of a spool 24, the hydraulic pressure for operating the launching members inputted through the first hydraulic line 19 is outputted toward the forward clutch 13 when the shift-range 25 is in the forward range D, and toward the reverse brake 11 when the shift-range 25 is in the reverse range R.

A hydraulic pressure supplied through the fourth hydraulic line 15 is supplied to a switching valve 30 as a control pressure, such that the forward clutch 13 is controlled thereby.

A hydraulic pressure supplied to a direction valve 17 through a fifth hydraulic line 21 is directed to the forward clutch 13 or reverse brake 11 for cooling it.

That is, at the forward range D, a hydraulic pressure is supplied from the switching valve 30 to the direction valve 17 through the sixth hydraulic line 33 as a control pressure of the direction valve 17, and the hydraulic pressure supplied to the direction valve 17 through the fifth hydraulic line 21 is supplied to the forward clutch 13 through a forward clutch lubrication hydraulic line 51 so as to cool the forward clutch 13.

At the reverse range R, the hydraulic pressure supplied from the manual valve 23 to the reverse brake 11 controls the direction valve 17, and therefore, the hydraulic pressure supplied to the direction valve 17 through the fifth hydraulic line 21 is supplied to the reverse brake 11 through a reverse brake lubrication hydraulic line 52 so as to cool the reverse brake 11.

According to such a conventional cooling apparatus of a CVT, a direction valve 17 is necessarily required, and thus, cost and time for manufacturing a transmission increases.

In addition, hydraulic lines 21 and 33 for connection of the direction valve 17 are also required, which also causes an increase of manufacturing process and cost.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in am effort to provide a cooling apparatus of a continuously variable transmission (CVT) having advantages of reducing process, cost, time, and process for manufacture.

An exemplary embodiment of the present invention provides a cooling apparatus of a CVT that uses a forward clutch and a reverse brake as launching clutches. The exemplary cooling apparatus includes: a manual valve that receives and outputs a first hydraulic pressure for operating the launching clutches and that receives and outputs a second hydraulic pressure for cooling the launching clutches; a first hydraulic line for supplying the first hydraulic pressure to the manual valve; a second hydraulic line for supplying the first hydraulic pressure from the manual valve to the forward clutch; a third hydraulic line for supplying the second hydraulic pressure to the manual valve; and a fourth hydraulic line for supplying the second hydraulic pressure from the manual valve to the forward clutch.

The exemplary cooling apparatus may further include: a fifth hydraulic line for supplying the first hydraulic pressure from the manual valve to the reverse brake; and a sixth hydraulic line for supplying the second hydraulic pressure from the manual valve to the reverse brake.

The manual valve may include a first spool that moves in order to enable the first hydraulic pressure to be selectively outputted to the second hydraulic line or the fifth hydraulic line.

The manual valve may further include a second spool that moves in order to enable the second hydraulic pressure to be selectively outputted to the fourth hydraulic line or the sixth hydraulic line.

The first and second spools may be integrally formed and move in the same direction.

The manual valve may include: a lubrication hydraulic pressure input port connected with the third hydraulic line; a forward clutch lubricating hydraulic pressure output port connected with the fourth hydraulic line; and a reverse brake lubricating hydraulic pressure output port connected with the sixth hydraulic line.

The lubrication hydraulic pressure input port may be arranged between the forward clutch lubricating hydraulic pressure output port and the reverse brake lubricating hydraulic pressure output port.

According to an exemplary embodiment of the present invention, a separate valve for controlling the launching clutches is not additionally required. Therefore, the cost and time production cost and time can be decreased, and the manufacturing process can be simplified.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram that shows a cooling apparatus of a CVT according to an exemplary embodiment of the present invention.

FIG. 2 is a schematic diagram that shows a manual valve according to an exemplary embodiment of the present invention.

FIG. 3 is a schematic diagram that shows a conventional cooling apparatus of a CVT.

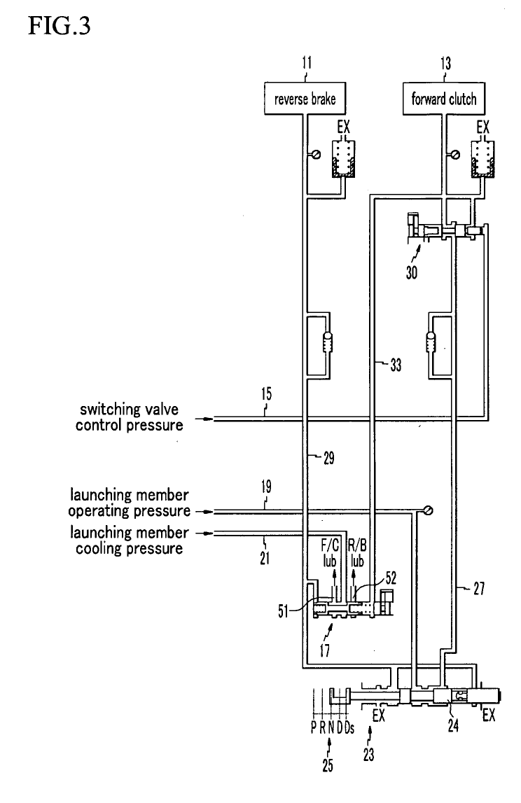

It should be understood that the appended drawings are not necessarily to scale, resenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

In the description hereinbelow, the expression “launching clutch” should not be understood to be limited to a clutch that is different from a brake, although in contains a word “clutch”. On the contrary, considering that the word “clutch” is widely used to cover both a clutch and a brake so as to mean a frictional member, the expression “launching clutch” is used to cover both a forward clutch and a reverse brake, for better understanding of the present invention of a person or ordinary skill in the art.

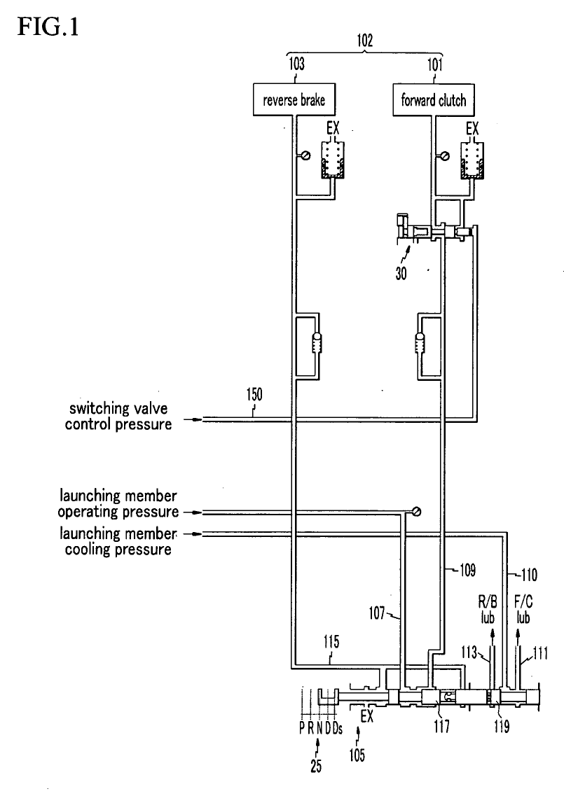

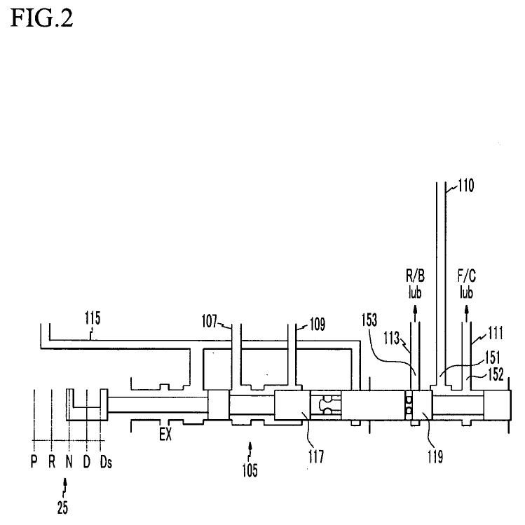

FIG. 1 is a schematic diagram that shows a cooling apparatus of a CVT according to an exemplary embodiment of the present invention. FIG. 2 is a schematic diagram that shows a manual valve according to an exemplary embodiment of the present invention.

As shown in FIG. 1, a cooling apparatus of a CVT according to an exemplary embodiment of the present invention uses a forward clutch 101 and a reverse brake 103 as launching clutches 102, and it includes a manual valve 105 and first, second, third, fourth, fifth, sixth, and seventh hydraulic lines 107, 109, 110, 111, 115, 113, and 150.

The manual valve 105 receives and outputs a first hydraulic pressure for operating the launching clutches 102. The manual valve 105 further receives and outputs a second hydraulic pressure for cooling and lubricating the launching clutches 102.

The forward clutch 101 is operated when a vehicle equipped with the CVT is driven forward, and the reverse brake 103 is operated when the vehicle is driven rearward.

The first hydraulic pressure is supplied to the manual valve 105 through a first hydraulic line 107, and is supplied from the manual valve 105 to the launching clutches 102 in order to operate the launching clutches 102, i.e., the forward clutch 101 and the reverse brake 103. In detail, the first hydraulic pressure is supplied to the manual valve 105 through a first hydraulic line 107, and the first hydraulic pressure is supplied from the manual valve 105 to the forward clutch 101 through a second hydraulic line 109 or to the reverse brake 103 through a fifth hydraulic line 115.

The second hydraulic pressure is supplied to the manual valve 105 through the third hydraulic line 110 in order to cool the launching clutches 102, i.e., the forward clutch 101 and the reverse brake 103. In detail, the second hydraulic pressure is supplied to the manual valve 105 through a third hydraulic line 110, and the second hydraulic pressure is supplied from the manual valve 105 to the forward clutch 101 through a fourth hydraulic line 111 or to the reverse brake 103 through a sixth hydraulic line 113.

A hydraulic pressure supplied through a seventh hydraulic line 150 acts on a switching valve 30 as its control pressure, so as to control the launching clutches 102.

The structure of the manual valve 105 as an exemplary embodiment of the present invention will be followed.

The manual valve 105 includes a first spool 117 and a second spool 119 as shown in FIG. 2, such that the first hydraulic pressure for operating the launching clutches 102 and the second hydraulic pressure for cooling the launching clutches 102 may be controlled as described below.

According to a movement of the first spool 117, the first hydraulic pressure as operating pressure is selectively outputted therefrom through the second hydraulic line 109 or the fifth hydraulic line 115 depending on the shift-range 25. According to a movement of the second spool 119, the second hydraulic pressure as cooling pressure is selectively outputted therefrom through the fourth hydraulic line 111 or the sixth hydraulic line 113 depending on the shift-range 25.

According to an exemplary embodiment of the present invention, the first spool 117 and the second spool 119 may be integrally formed. Therefore, by changing the shift-range 25, the first and second spools 117 and 119 simultaneously move in the same direction, and thus the flow of the first and second hydraulic pressures are simultaneously controlled.

As shown in FIG. 2, the manual valve 105 includes a lubrication hydraulic pressure input port 151 connected with the third hydraulic line 110, a forward clutch lubricating hydraulic pressure output port 152 connected with the fourth hydraulic line 111, and a reverse brake lubricating hydraulic pressure output port 153 connected with the sixth hydraulic line 113.

The lubrication hydraulic pressure input port 151 is arranged between the forward clutch lubricating hydraulic pressure output port 152 and the reverse brake lubricating hydraulic pressure output port 153. By such a port configuration, according to left or right movements of the second spool 119, the second hydraulic pressure is selectively outputted through the forward clutch lubricating hydraulic pressure output port 152 or the reverse brake lubricating hydraulic pressure output port 153. Therefore, the second hydraulic pressure is selectively supplied to the forward clutch 101 or the reverse brake 103.

Explanation based on the operation of the shift-range 25 will be followed.

When the shift-range 25 is placed at the forward range D or the sports range Ds as shown in FIGS. 1 and 2, the first spool 117 and the second spool 119 move to the right direction in the drawing.

Therefore, the first hydraulic pressure is supplied to the manual valve 105 through the first hydraulic line 107, and is outputted therefrom to the forward clutch 101 through the second hydraulic line 109.

Furthermore, the second hydraulic pressure inputted to the manual valve 105 through the third hydraulic line 110 is outputted to the fourth hydraulic line 111 through the forward clutch lubricating hydraulic pressure output port 152, and the hydraulic pressure of the fourth hydraulic line 111 is supplied to the forward clutch 101 for lubrication and cooling thereof.

However, when the shift-range 25 is placed at the reverse range R, the first spool 117 and second spool 119 moves to the left direction in the drawing.

Therefore, the first hydraulic pressure is supplied to the manual valve 105 through the first hydraulic line 107, and is outputted therefrom to the reverse brake 11 through the fifth hydraulic line 115.

Furthermore, the second hydraulic pressure inputted to the manual valve 105 through the third hydraulic line 110 is outputted to the sixth hydraulic line 113 through the reverse brake lubricating hydraulic pressure output port 153, and the second hydraulic pressure of the sixth hydraulic line 113 is supplied to the reverse brake 103 for lubrication and cooling thereof.

In brief, when the shift-range 25 is placed at the forward range D or the sports range Ds, the first spool 117 and the second spool 119 move to the right direction in the drawing. Accordingly, the first hydraulic pressure is inputted to the manual valve 105 through the first hydraulic line 107, is outputted therefrom through the second hydraulic line 109 and is supplied to the forward clutch 101. The second hydraulic pressure is inputted to the manual valve 105 through the third hydraulic line 110, is outputted therefrom through the fourth hydraulic line 111 and is supplied to the forward clutch 101. Therefore the first hydraulic pressure works as a operating pressure and the second hydraulic pressure works as a cooling pressure.

When the shift-range 25 is placed at the reverse range R, the first spool 117 and the second spool 119 move to the left direction in the drawing. Accordingly, the first hydraulic pressure is inputted to the manual valve 105 through the first hydraulic line 107 and is outputted therefrom through the fifth hydraulic line 115. The second hydraulic pressure is inputted to the manual valve 105 through the third hydraulic line 110, is outputted therefrom through the sixth hydraulic line 113 and is supplied to the reverse brake 11. Therefore the first hydraulic pressure works as a operating pressure and the second hydraulic pressure works as a cooling pressure.

According to such an exemplary embodiment of the present invention, both of the first hydraulic pressure for operating the launching clutches 102 and the second hydraulic pressure for cooling the launching clutches 102 are simultaneously controlled by the movement of the manual valve 105 that moves the first spool 117 and the second spool 119 according to the change of the shift-range 25.

Accordingly, a separate valve for controlling the second hydraulic pressure is not additionally required. Therefore, the cost and time production cost and time can be decreased, and the manufacturing process can be simplified.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A cooling apparatus of a continuously variable transmission (CVT) that uses a forward clutch and a reverse brake as launching clutches, the cooling apparatus comprising;
a manual valve that receives and outputs a first hydraulic pressure for operating the launching clutches and that receives and outputs a second hydraulic pressure for cooling, the launching clutches;
a first hydraulic line for supplying the first hydraulic pressure to the manual valve;
a second hydraulic line for supplying the first hydraulic pressure from the manual valve to the forward clutch;
a third hydraulic line for supplying the second hydraulic pressure to the manual valve; and
a fourth hydraulic line for supplying the second hydraulic pressure from the manual valve to the forward clutch.

2. The cooling apparatus of claim 1, further comprising:
a fifth hydraulic line for supplying the first hydraulic pressure from the manual valve to the reverse brake; and
a sixth hydraulic line for supplying the second hydraulic pressure from the manual valve to the reverse brake.

3. The cooling apparatus of claim 2, wherein the manual valve comprises a first spool that moves in order to enable the first hydraulic pressure to be selectively outputted to the second hydraulic line or the fifth hydraulic line.

4. The cooling apparatus of claim 3, wherein the manual valve further comprises a second spool that moves in order to enable the second hydraulic pressure to be selectively outputted to the fourth hydraulic line or the sixth hydraulic line.

5. The cooling apparatus of claim 4, wherein the first and second spools are integrally formed.

6. The cooling apparatus of claim 5, wherein the first and second spools moves in a same direction.

7. The cooling apparatus of claim 2, wherein the manual valve comprises:
a lubrication hydraulic pressure input port connected with the third hydraulic line;
a forward clutch lubricating hydraulic pressure output port connected with the fourth hydraulic line; and
a reverse brake lubricating hydraulic pressure output port connected with the sixth hydraulic line.

8. The cooling apparatus of claim 7, wherein the lubrication hydraulic pressure input port is arranged between the forward clutch lubricating hydraulic pressure output port and the reverse brake lubricating hydraulic pressure output port.
